(19) United States
(12) Patent Application Publication
(10) Pub. No.: US 2019/0219114 A1
(43) Pub. Date: Jul. 18, 2019

(54) CALIPER ASSEMBLY

(71) Applicant: ADVICS CO., LTD., Kariya-shi, Aichi-ken (JP)

(72) Inventor: Naoya MIYAHARA, Nisshin-shi, Aichi-ken (JP)

(73) Assignee: ADVICS CO., LTD., Kariya-shi, Aichi-ken (JP)

(21) Appl. No.: 16/337,157

(22) PCT Filed: Sep. 20, 2017
(86) PCT No.: PCT/JP2017/033830

§ 371 Date: Mar. 27, 2019

(30) Foreign Application Priority Data
Sep. 30, 2016 (JP) 2016-193626

(51) Int. Cl. F16D 65/097; F16D 55/228

(52) U.S. Cl. CPC F16D 65/0972; F16D 55/228; F16D 65/0974

(57) ABSTRACT

A brake pad is incorporated into a caliper so as to be movable in the axial direction of a rotor and rotatable around a rotation axis; a piston which presses the brake pad toward a disk rotor; and biasing members which bias the brake pad in order to hold the brake pad, wherein: the brake pad has contact sections, which are sections contacting the biasing members; the contacting sections have contact planes coinciding with virtual planes including the rotation axis of the brake pad; and the biasing members bias the contact planes in a direction perpendicular to the contact planes.

### TECHNICAL FIELD

The present invention relates to a caliper assembly.

### BACKGROUND ART

For example, a caliper assembly includes a caliper (housing), a brake pad incorporated in the caliper, a piston that presses the brake pad toward a disc rotor, a plurality of shaft-like members that support the brake pad, and a biasing member that biases the brake pad to hold the brake pad. In such a caliper assembly, in terms of design, a slight play (gap allowing relative movement) is provided in the engagement relationship between the brake pad and the shaft-like member on the outer peripheral side. That is, in this caliper assembly, the brake pad can slightly rotate with respect to the caliper by the amount of play. The biasing member holds the brake pad by biasing the brake pad, thereby alleviating the vibration of the brake pad, which is generated due to the play, and the collision sound of the brake pad and the torque receiving surface. A caliper assembly including a biasing member for holding a brake pad is described in, for example, Japanese Patent Publication No. 2008-527272.

### CITATIONS LIST

### Patent Literature

Patent Literature 1: Japanese Patent Publication No. 2008-527272

### SUMMARY OF INVENTION

### Technical Problems

Here, the inventor of the present invention newly focused on a fact that in the caliper assembly as described above, the spring characteristics of the biasing member can fluctuate when the brake pad rotates. The spring characteristic means the relationship between the load the brake pad receives from the biasing member and the stroke (displacement amount, rotation amount) of the brake pad. When the spring characteristics of the biasing member fluctuate due to the rotation of the brake pad, the original performance (e.g., spring constant) of the biasing member aimed at by design cannot be realized, which may cause abnormal noise and dragging.

In light of the foregoing, it is an object of the present invention to provide a caliper assembly capable of suppressing fluctuation in the spring characteristics of a biasing member.

### Solutions to Problems

A caliper assembly of the present invention includes a caliper disposed so as to cross one portion of an outer peripheral portion of a disc rotor; a brake pad incorporated in the caliper so as to be movable in an axial direction of the rotor, which is an axial direction of the disc rotor, and rotatable around a rotation axis parallel to the axial direction of the rotor with respect to the caliper; a piston assembled to the caliper to press the brake pad toward the disc rotor, and biasing members which bias the brake pad to hold the brake pad. The brake pad has contact sections, which are sections in contact with the biasing member, the contact sections have contact planes that coincide with virtual planes including the rotation axis of the brake pad, and each of the biasing members biases the contact plane in a direction perpendicular to the contact plane.

### Advantageous Effects of Invention

According to the present invention, with respect to the rotating direction of the brake pad (one side in rotating direction), the biasing member biases the brake pad in the opposite direction (other side in rotating direction) at the time of the brake operation. Thus, slippage (excluding slippage in the axial direction of the rotor) is less likely to occur between the brake pad and the biasing member at the time of the brake operation. That is, according to the present invention, the generation of the frictional force at the contact surface between the brake pad and the biasing member is suppressed, the fluctuation of the load applied to the brake pad is suppressed, and the fluctuation of the spring characteristic is suppressed.

### BRIEF DESCRIPTION OF DRAWINGS

FIG. 1 is a cross-sectional view showing a configuration of a caliper assembly of a first embodiment.

FIG. 2 is an explanatory view for explaining a piston of the first embodiment.

FIG. 3 is a configuration view showing a configuration of the caliper assembly of the first embodiment.

FIG. 4 is a conceptual view for explaining a relationship between a back plate and a biasing member of the first embodiment.

FIG. 5 is an explanatory view for explaining the operation of a base point of a second biasing member of the first embodiment.

FIG. 6 is a conceptual diagram for explaining a relationship between a back plate and a biasing member in a conventional caliper assembly.

FIG. 7 is an explanatory diagram for explaining a spring characteristic.

FIG. 8 is a configuration view showing a configuration of a caliper assembly according to a second embodiment.

FIG. 9 is a configuration view showing a configuration of a caliper assembly according to a third embodiment.

FIG. 10 is a conceptual diagram showing a configuration of a first contact section and a curved portion of the third embodiment.

FIG. 11 is a configuration view showing a configuration of a caliper assembly according to a fourth embodiment.

### DESCRIPTION OF EMBODIMENTS

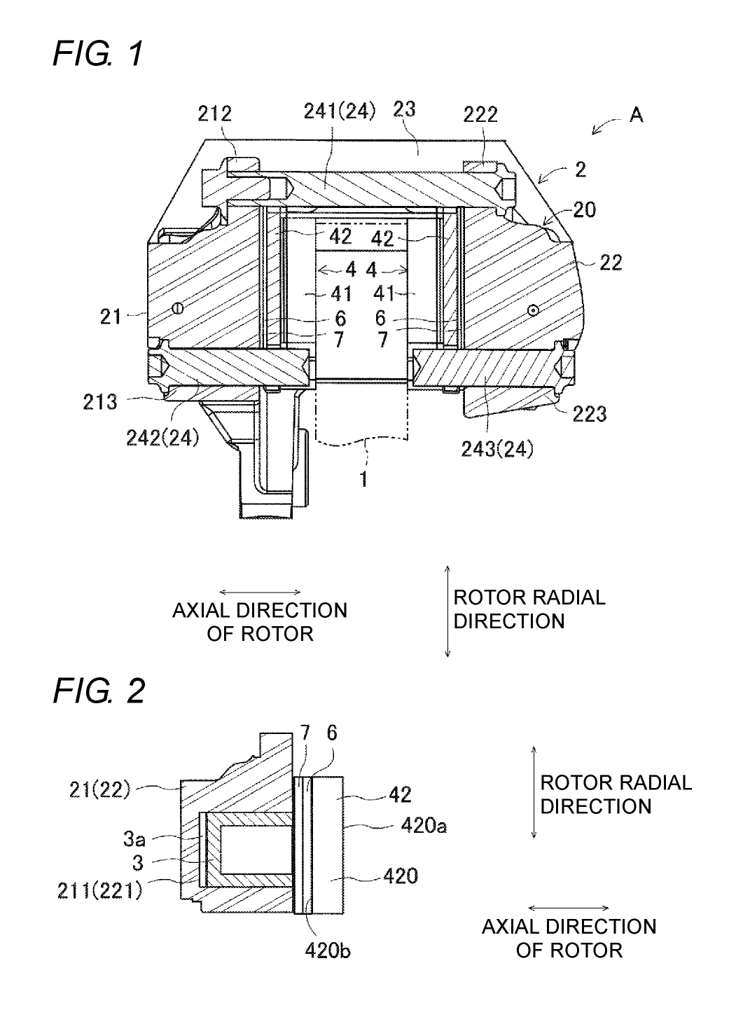

Hereinafter, a caliper assembly of the present embodiment will be described using a piston opposing type disc brake device for a vehicle by way of example. As shown in FIG. 1, a disc brake device A includes a disc rotor 1 and a caliper assembly 2. The disc rotor 1 is a disc member assembled to an axle hub (not shown) to rotate integrally with the wheel. In the description, the radial direction of the disc rotor 1 is referred to as “rotor radial direction”, the circumferential direction of the disc rotor 1 is referred to as “rotor circumferential direction”, and the axial direction of the disc rotor 1 is referred to as “axial direction of the rotor”. Furthermore, “piston 3” of the “piston 3 side in the axial direction of the rotor” means the piston 3 on one side in the description of portion on one side (brake pad set etc.). In addition, each figure used for the description is a conceptual view, and the shape of each portion is not necessarily strict in some cases. FIG. 1 is a cross-sectional view of the caliper assembly 2 taken along a plane extending in the axial direction of the rotor and the rotor radial direction, and is a configuration explanatory view in which cylinders 211 and 221, a piston 3, a bridge 231, and biasing members 51 to 53, and the like are omitted.

### First Embodiment

The caliper assembly 2 is a device for generating a braking force with respect to the rotation of the disc rotor 1. As shown in FIGS. 1 to 3, the caliper assembly 2 includes a caliper 20, a plurality of pistons 3, a pair of brake pads 4, a pair of first biasing members 51, a pair of second biasing members 52, a pair of third biasing members 53, an inner shim 6, and an outer shim 7. Regarding the pair of members, description of one member will be given and the description of the other member will be omitted.

The caliper 20 is a housing portion mainly fixed to a supporting body (not shown) of a vehicle. The caliper 20 includes an inner housing portion 21, an outer housing portion 22, a coupling portion 23, and a supporting shaft portion 24. First, the supporting shaft portion 24 is a member that supports the brake pads 4 such that the brake pads 4 are movable in the axial direction of the rotor in the caliper 20. Although details will be described later, the supporting shaft portion 24 is configured by an outer peripheral supporting shaft 241 and inner peripheral supporting shafts 242, 243.

The inner housing portion 21 and the outer housing portion 22 are opposed to each other across the disc rotor 1. The inner housing portion 21 is disposed on the inner side in the axial direction of the rotor of the disc rotor 1. In the inner housing portion 21, a plurality of cylinders 211 are formed in correspondence with a plurality of pistons 3. Furthermore, a supporting portion 212 that supports one end of the outer peripheral supporting shaft 241 is formed at the outer side portion in the rotor radial direction of the inner housing portion 21. A supporting portion 213 that supports one end of the inner peripheral supporting shaft 242 is formed at the inner side portion in the rotor radial direction of the inner housing portion 21.

The outer housing portion 22 is disposed on the outer side in the axial direction of the rotor of the disc rotor 1. In the outer housing portion 22, a plurality of cylinders 221 are formed in correspondence with a plurality of pistons 3. Furthermore, a supporting portion 222 that supports the other end of the outer peripheral supporting shaft 241 is formed at the outer side portion in the rotor radial direction of the outer housing portion 22. A supporting portion 223 that supports one end of the inner peripheral supporting shaft 243 is formed at the inner side portion in the rotor radial direction of the outer housing portion 22. The coupling portion 23 is a portion coupling the inner housing portion 21 and the outer housing portion 22. The coupling portion 23 is constituted by a plurality of bridges 231. The plurality of bridges 231 allow the interior of the caliper assembly 2 to be exposed.

The outer peripheral supporting shaft 241 is a circular column shaped member one end of which is supported by the supporting portion 212 of the inner housing portion 21 and the other end of which is supported by the supporting portion 222 of the outer housing portion 22. The outer peripheral supporting shaft 241 is disposed at the outer side portion in the rotor radial direction of the caliper 20 so that the axial direction is parallel to the axial direction of the rotor. The outer peripheral supporting shaft 241 is provided integrally with the inner housing portion 21 and the outer housing portion 22.

The inner peripheral supporting shaft 242 is a circular column shaped member whose one end is supported by the supporting portion 213 of the inner housing portion 21. The inner peripheral supporting shaft 242 is disposed at the inner side portion in the rotor radial direction of the caliper 20 so that the axial direction is parallel to the axial direction of the rotor. The inner peripheral supporting shaft 242 is provided integrally with the inner housing portion 21. The inner peripheral supporting shaft 243 is a circular column shaped member whose one end is supported by the supporting portion 223 of the outer housing portion 22. The inner peripheral supporting shaft 243 is disposed at the inner side portion in the rotor radial direction of the caliper 20 so that the axial direction is parallel to the axial direction of the rotor. The inner peripheral supporting shaft 243 is provided integrally with the outer housing portion 22. The supporting shaft portion 24 may be screwed to the supporting portions 212, 222, 213, 223.

The piston 3 is a member for pressing the brake pad 4 toward the disc rotor 1. As shown in FIG. 2, the piston 3 is a bottomed tubular member in which the brake pad 4 side is opened, and which includes a bottom surface on a bottom surface side of the cylinder 211 or 221. In the caliper 20, six pistons 3 are arranged. The three pistons 3 on the inner housing portion 21 side are each arranged in the corresponding cylinder 211. The three pistons 3 on the outer housing portion 22 side are arranged in the corresponding cylinder 221. The piston 3 is assembled to the cylinder 211 or 221 in a liquid-tight manner and so as to be slidable in the axial direction of the rotor. An oil chamber 3a is formed between the piston 3 and the cylinder 211 or 221. At the time of braking, the piston 3 moves forward in the axial direction of the rotor by the hydraulic fluid supplied to the oil chamber 3a, and presses the pair of brake pads 4 toward the disc rotor 1. Respective oil chambers 3a are communicated with each other through an oil passage (not shown). Furthermore, the supply of hydraulic fluid to the oil chamber 3a is performed by, for example, a master cylinder, an actuator, or the like.

The pair of brake pads 4 is incorporated in the caliper 20. The pair of brake pads 4 is composed of a brake pad 4 arranged on the inner housing portion 21 side and a brake pad 4 arranged on the outer housing portion 22 side. The brake pad 4 arranged in the inner housing portion 21 and the brake pad 4 arranged in the outer housing portion 22 have a similar configuration, and thus one brake pad 4 will be described.

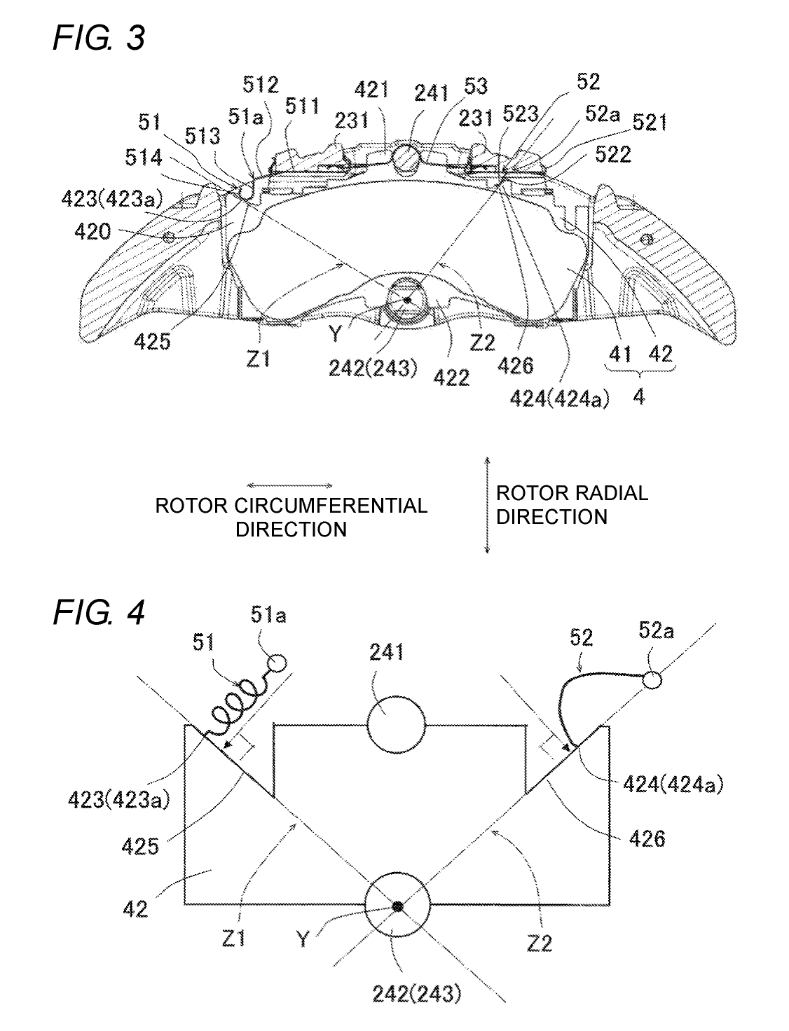

As shown in FIG. 3, the brake pad 4 includes a friction material 41 for generating a frictional force by slidable contact with the disc rotor 1 and a back plate 42 for supporting the back surface of the friction material 41. The friction material 41 of the present embodiment is formed so that the longitudinal direction as a whole is the rotor circumferential direction. The friction material 41 may also be referred to as a lining in the market.

The back plate 42 includes a back plate main body portion 420, a first groove portion 421, a second groove portion 422, a first contact section 423, and a second contact section 424. The back plate main body portion 420 is a plate-like member in which the friction material 41 is fixed to a first surface 420a on the disc rotor 1 side and the inner shim 6 is disposed on a second surface 420b on the piston 3 side.

The first groove portion 421 is formed at a central part in the rotor circumferential direction on the outer side in the rotor radial direction of the back plate 42. The first groove portion 421 is formed to a recessed shape (e.g., V shape or U shape) recessed toward the inner side in the rotor radial direction so as to be engageable with the outer peripheral supporting shaft 241. In other words, the first groove portion 421 is a portion projecting out to a recessed shape from the back plate main body portion 420 toward the outer side in the rotor radial direction. The first groove portion 421 is arranged so as to be spaced apart with respect to at least one side in the rotor circumferential direction of the outer peripheral supporting shaft 241 so that the brake pad 4 can be rotated by a predetermined amount about the axis center of the inner peripheral supporting shafts 242 and 243. That is, the brake pad 4 is arranged so as to be rotatable by a predetermined amount with respect to the caliper 20 with the central axis of the inner peripheral supporting shafts 242, 243 parallel to the axial direction of the rotor (also referred to as thickness direction of caliper 20) as a rotation axis Y. At the time of brake operation, the first groove portion 421 constitutes a torque receiving surface.

The second groove portion 422 is formed at a central part in the rotor circumferential direction on the inner side in the rotor radial direction of the back plate 42. The second groove portion 422 is formed to a recessed shape (e.g., V shape or U shape) recessed toward the outer side in the rotor radial direction so as to be engageable with the inner peripheral supporting shafts 242, 243. The second groove portion 422 is disposed so as to be slidable with respect to the inner peripheral supporting shafts 242 and 243. The brake pad 4 of the present embodiment is assembled to the supporting shaft portion 24 so as to be rotatable by a predetermined amount (slight amount) about the axis center of the inner peripheral supporting shafts 242, 243. The inner peripheral supporting shafts 242 and 243 are brought into contact with the opposing inner circumferential surfaces on both sides of the rotor circumferential direction in the elliptical second groove portion 422 that is biased by the biasing members 51 and 52 and.

As shown in FIGS. 3 and 4, the first contact section 423 is a portion brought into contact with the first biasing member 51, and is formed on the outer peripheral surface of the back plate 42. The outer peripheral surface of the back plate 42 is an outer surface excluding both end faces in the axial direction of the rotor of the back plate 42. The first contact section 423 of the first embodiment is located on a first inclined surface 425 formed at a portion on one side in the rotor circumferential direction on the outer side in the rotor radial direction of the back plate 42. The first inclined surface 425 is formed so as to be included in a first virtual plane Z1 including the rotation axis Y of the brake pad 4. In other words, the first inclined surface 425 coincides with the first virtual plane Z1. In other words, the first inclined surface 425 is formed on the first virtual plane Z1. Since the first inclined surface 425 and the first virtual plane Z1 coincide, they are parallel. The rotation axis (central axis) Y is a straight line having a length.

The first contact section 423 is a portion of the first inclined surface 425 with which the first biasing member 51 is brought into contact. The first contact section 423 receives a biasing force from the first biasing member 51 in a direction perpendicular to the first inclined surface 425. That is, the first contact section 423 includes a first contact plane 423a that coincides with the first virtual plane Z1, and the first biasing member 51 biases the first contact plane 423a in a direction perpendicular to the first contact plane 423a. In the present embodiment, the entire first contact section 423 constitutes the first contact plane 423a.

The second contact section 424 is a portion brought into contact with the second biasing member 52, and is formed on the outer peripheral surface of the back plate 42. The second contact section 424 of the first embodiment is located on a second inclined surface 426 formed at a portion on the other side in the rotor circumferential direction on the outer side in the rotor radial direction of the back plate 42. The second inclined surface 426 is formed so as to be included in a second virtual plane Z2 including the rotation axis Y of the brake pad 4. In other words, the second inclined surface 426 coincides with the second virtual plane Z2. In other words, the second inclined surface 426 is formed on the second virtual plane Z2. Since the second inclined surface 426 and the second virtual plane Z2 coincide, they are parallel. The second virtual plane Z2 is a plane different from the first virtual plane Z1. The virtual planes Z1 and Z2 including the rotation axis Y are planes extending in the radial direction of the virtual circular column having the rotation axis Y as the central axis and also are planes extending in the direction perpendicular to the rotation axis Y.

The second contact section 424 is a portion of the second inclined surface 426 with which the second biasing member 52 is brought into contact. The second contact section 424 receives a biasing force from the second biasing member 52 in the direction perpendicular to the second inclined surface 426. That is, the second contact section 424 includes a second contact plane 424a that coincides with the second virtual plane Z2, and the second biasing member 52 biases the second contact plane 424a in a direction perpendicular to the second contact plane 424a. In the present embodiment, the entire second contact section 424 constitutes the second contact plane 424a.

The first biasing member 51 is a plate spring and is in contact with the first contact section 423 to bias it toward one side in the rotating direction with respect to the brake pad 4. Specifically, the first biasing member 51 is configured by a base end portion 511, a first portion 512, a second portion 513, and a curved portion 514. The base end portion 511 is formed in a substantially U shape and is fixed (fitted) to the bridge 231 of the caliper 20. The first portion 512 is formed to a flat plate shape and projects out to one side in the rotor circumferential direction from the base end portion 511. The second portion 513 is formed into a flat plate shape and extends from the distal end of the first portion 512 so as to be bent toward the inner side in the rotor radial direction with respect to the first portion 512. The curved portion 514 is formed in a substantially C shape and is curved so as to be convex from the distal end of the second portion 513 toward the back plate 42 side.

The curved portion 514 is in contact with the first contact section 423 and presses the first contact section 423. A base point 51a where the biasing force of the first biasing member 51, which is a plate spring, is generated is the root of the second portion 513 (distal end of first portion 512). The base point 51a is formed in a shaft shape extending parallel to the rotation axis Y, and can also be said to be a base axis. The first biasing member 51 is configured so that a portion on the curved portion 514 side from the base point 51a deforms to exert the biasing force. That is, the portion on the base end portion 511 side of the base point 51a has a high rigidity and is less likely to deform. The base point 51a is located on a perpendicular line (normal line) of the first contact plane 423a.

The second biasing member 52 is a plate spring and is in contact with the second contact section 424 to bias it toward the other side in the rotating direction with respect to the brake pad 4. Specifically, the second biasing member 52 includes a base end portion 521, a first portion 522, and a curved portion 523. The base end portion 521 is formed in a substantially U shape, and is fixed (fitted) to a bridge 231 different from the bridge 231 to which the first biasing member 51 is fixed. The first portion 522 projects out from the base end portion 521 and is slightly curved so as to be convex toward the outer side in the rotor radial direction. The curved portion 523 projects out from the distal end of the first portion 522 and is slightly curved so as to be convex toward the back plate 42 side.

The curved portion 523 is in contact with the second contact section 424 and presses the second contact section 424. A base point 52a where the biasing force of the second biasing member 52, which is a plate spring, is generated is the root of the first portion 522. The base point 52a is formed in a shaft shape extending parallel to the rotation axis Y, and can also be said to be a base axis. The second biasing member 52 is configured so that a portion on the curved portion 523 side from the base point 52a deforms to exert the biasing force. The base point 52a is located on the second virtual plane Z2. The brake pad 4 is configured to be slidable in the axial direction of the rotor with respect to the first biasing member 51 and the second biasing member 52.

In the first embodiment, the biasing force of the first biasing member 51 is larger than the biasing force of the second biasing member 52. Thus, the brake pad 4 is incorporated in the caliper 20 in a state of being in contact with the torque receiving surface at a position rotated to one side in the rotor circumferential direction (forward moving side in rotating direction of brake pad 4) with respect to the central position. That is, the brake pad 4 does not rotate when the brake is operated during the forward movement of the vehicle, but rotates while pushing up the biasing members 51 and 52 when the brake is operated during the backward movement of the vehicle. In the first embodiment, the arrangement of each portion is described based on a state (initial state) in which the caliper assembly 2 is mounted on the vehicle and the brake is not operated. Furthermore, the base points 51a, 52a can be said to be deflection points. The third biasing member 53 is a plate spring, is fixed to the outer peripheral supporting shaft 241, and biases the caliper 20 toward the outer side in the rotor radial direction. The inner shim 6 and the outer shim 7 are disposed between the brake pad 4 and the piston 3.

As described above, the caliper assembly 2 of the first embodiment includes the caliper 20 arranged so as to cross one portion of the outer peripheral portion of the disc rotor 1, the brake pad 4 incorporated in the caliper 20 so as to be movable in the axial direction of the rotor (by predetermined amount), which is the axial direction of the disc rotor 1 with respect to the caliper 20 and rotatable (by predetermined amount) around the rotation axis Y parallel to the axial direction of the rotor, the piston 3 assembled to the caliper 20 to press the brake pad 4 toward the disc rotor 1, and biasing members 51, 52 for biasing the brake pad 4 to hold the brake pad 4, where the brake pad 4 includes contact sections 423, 424, which are portions in contact with the biasing members 51, 52, the contact section 423, 424 include contact planes 423a, 424a that coincide with the virtual planes Z1, Z2 including the rotation axis Y of the brake pad 4, and the biasing members 51, 52 bias the contact planes 423a, 424a in a direction perpendicular to the contact planes 423a, 424a. Further, the biasing members 51 and 52 are disposed such that the base points 51a and 52a where the biasing force is generated are located on the perpendicular line of the contact planes 423a and 424a or on the virtual planes Z1 and Z2. The caliper assembly 2 includes supporting shafts 241, 242, 243 for supporting the brake pad 4 so as to be rotatable by a predetermined amount. It can also be said that the brake pad 4 is arranged in the caliper 20 so as to be movable in the thickness direction (width direction) of the caliper 20 and rotatable in the longitudinal direction of the caliper 20.

Here, the operation of the disc brake device of the present embodiment at the time of brake operation (time of braking) will be described. When hydraulic fluid is supplied to each oil chamber 3a in accordance with the depression of a brake pedal (not shown), each piston 3 is driven toward the disc rotor 1 by the hydraulic pressure, and both brake pads 4 are pressed toward the disc rotor 1. As a result, the friction material 41 is slidably pressure contacted to the disc rotor 1, and the disc rotor 1 is braked. When the depression of the brake pedal is released, the hydraulic fluid is discharged from each oil chamber 3a, and the braking of the disc rotor 1 is released.

At the time of the brake operation, the brake pad 4 rotates around the axis center of the inner peripheral supporting shafts 242, 243, and the inner circumferential surface (torque receiving surface) on one side of the rotor circumferential direction of the first groove portion 421 is brought into contact with the outer peripheral supporting shaft 241. The torque at the time of braking is received by the engagement portion between the first groove portion 421 and the outer peripheral supporting shaft 241 and the engagement portion between the second groove portion 422 and the inner peripheral supporting shafts 242 and 243. Thus, the behavior of the brake pad 4 stabilizes as compared with the configuration in which the torque at the time of braking is received by an unstable plane. Therefore, the occurrence of brake squeal due to unstable behavior at the time of braking is suppressed.

According to the present embodiment, in response to a very small rotational movement around the rotation axis Y of the brake pad 4 which may occur at the time of brake operation, either one of the first biasing member 51 and the second biasing member 52 applies a biasing force in a direction opposite to the rotating direction. For example, due to the magnitude of the biasing force of the biasing members 51, 52, the brake pad 4 supported on the forward moving side of the rotating direction than the central position at the time of non-brake operation rotates toward the backward moving side of the rotating direction by the brake operation at the time of the backward movement of the vehicle. At this time, the first biasing member 51 applies a biasing force in a direction opposite (forward moving side in the rotating direction) to the rotating direction of the brake pad 4. In contrast, the second biasing member 52 applies a biasing force in a direction opposite (backward moving side of the rotating direction) to the rotation toward the forward moving side of the rotating direction of the brake pad 4. In other words, frictional force due to slipping is unlikely to occur between the biasing members 51, 52 and the brake pad 4.

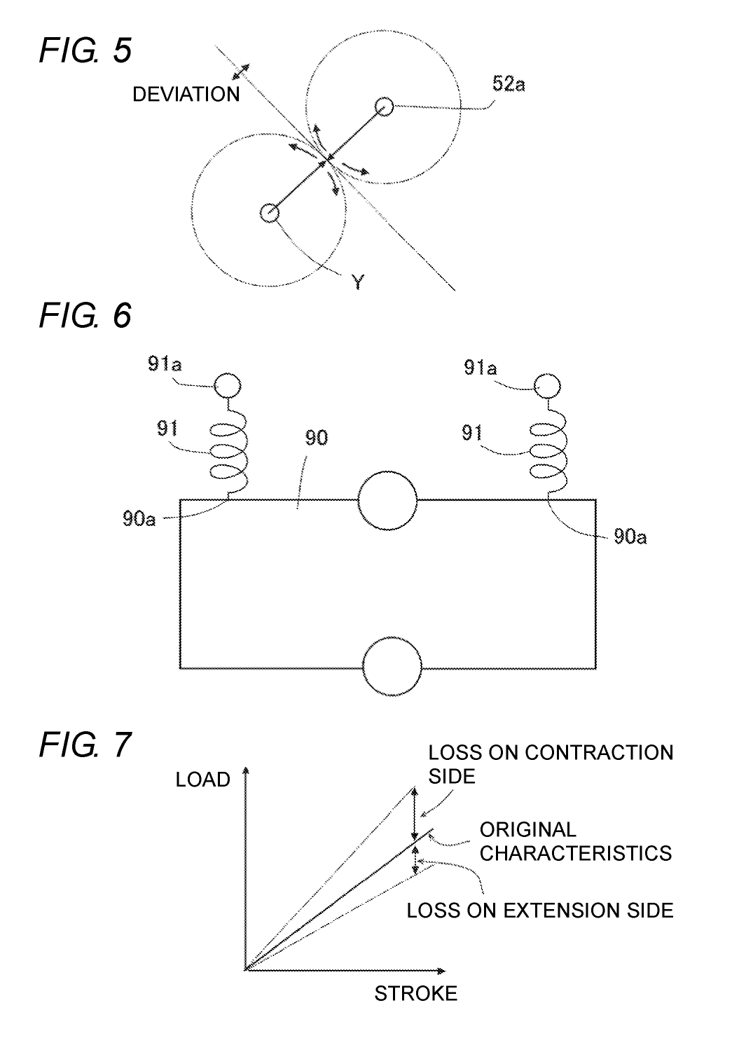

This is because the brake pad 4 has a contact plane 423a (424a) that coincides with the virtual plane Z1 (Z2) including the rotation axis Y and the biasing member 51 (52) applies the biasing force in a direction perpendicular to the contact plane 423a (424a). In order to accurately apply the vertical biasing force, the base point 51a of the first biasing member 51 is disposed on the perpendicular line of the contact plane 423a, and the base point 52a of the second biasing member 52 is disposed on the second virtual plane Z2. With this configuration, the movement of the seating surfaces (contact sections 423, 424) of the springs is suppressed, and slippage can be suppressed. The deviation in the direction between the force generated by the rotation about the rotation axis Y and the force generated by the rotation about the base point 52a can be suppressed to the minimum, as shown in FIG. 5, by arranging the base point 52a on the second virtual plane Z2. Since the rotation of the brake pad 4 is very small, this configuration exerts the same effect as arranging the base point on the perpendicular line of the contact plane.

According to the first embodiment, the fluctuation (hysteresis) of the spring characteristic of the first biasing member 51 or the second biasing member 52, which can occur at the time of brake operation, can be suppressed and the spring characteristic can be brought closer to the original characteristic of the spring. The spring characteristic is the relationship between the load received by the brake pad 4 from the biasing member 51 (52) and the stroke of the brake pad 4. When the spring characteristic becomes constant, the original performance by the design corresponding to the spring characteristic (i.e., the spring constant) can be exhibited.

For example, as shown in FIG. 6, in the configuration in which the plate spring 91 biases the brake pad 90 downward in the figure, when the brake pad 90 is rotationally moved, slippage (excluding slippage in the axial direction of the rotor, the same applies hereinafter) occurs on the contact surface 90a between the plate spring 91 and the brake pad 90. When the brake pad 90 rotates in the clockwise direction around the rotation axis Y, the plate spring 91 slides on the contact surface 90a in the clockwise direction about the base point 91a. That is, when the plate spring 91 is contracted, the frictional force increases and the load increases, whereas when the plate spring 91 is extended, the frictional force decreases due to slipping and the load decreases. As a result, a frictional force is generated on the contact surface 90a, the load received the plate spring 91 changes by the amount corresponding to the frictional force, and hysteresis occurs.

In the configuration as shown in FIG. 6, for example, as shown in FIG. 7, the original spring characteristic fluctuates due to the brake operation. In such a case, the original performance (spring characteristic, spring constant) aimed at the design cannot be obtained, and if the original performance of the design is not exhibited, this may cause the abnormal sound generation and degrade the fuel consumption as the load is maintained high and thus dragging gets worse. However, according to the first embodiment, the spring characteristic can be brought closer to the original characteristic and the fluctuation of the spring characteristic can be suppressed, so that the performance aimed at the design can be exhibited, and generation of abnormal sound as well as degradation of fuel consumption can be suppressed. Furthermore, it becomes possible to stably design the biasing member. Moreover, the space utilization efficiency can be enhanced by fixing the biasing members 51, 52 using the bridge 231 of the caliper 20. In the present embodiment, the biasing members 51, 52 are disposed in consideration of the rotational movement path of the brake pad 4.

### Second Embodiment

The second embodiment is different from the first embodiment mainly in the configuration of the biasing member. Therefore, different portions will be explained. In the description of the second embodiment, the drawings and explanations of the first embodiment can be referred to.

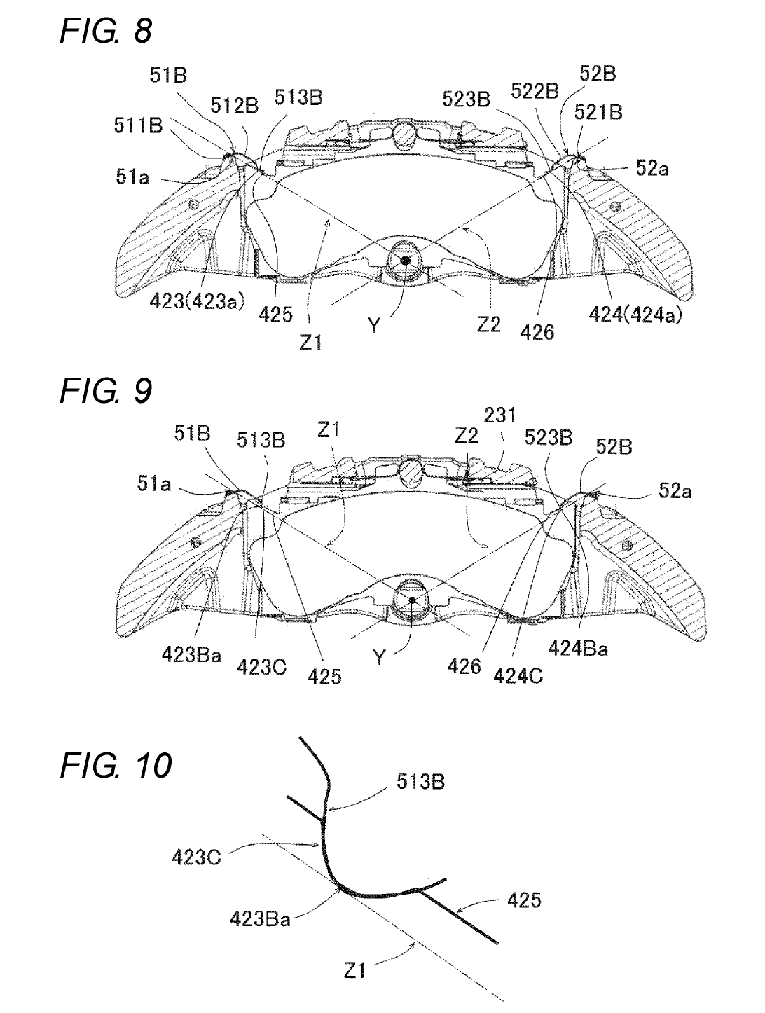

As shown in FIG. 8, a first biasing member 51B of the second embodiment is configured so that the base point 51a is located on the first virtual plane Z1 and the biasing force is applied perpendicularly to the first contact plane 423a. Specifically, the first biasing member 51B is configured by a base end portion 511B fixed to a portion of the caliper 20 that is not the bridge 231, an intermediate portion 512B extending toward the inner peripheral supporting shaft 242, and a curved portion 513B curved to be convex toward the brake pad 4 side and brought into contact with the first contact plane 423a.

A second biasing member 52B is configured so that the base point 52a is located on the second virtual plane Z2, and the biasing force is applied perpendicularly to the second contact plane 424a. Specifically, the second biasing member 52B is configured by a base end portion 521B fixed to a portion of the caliper 20 that is not the bridge 231, an intermediate portion 522B extending toward the inner peripheral supporting shaft 242, and a curved portion 523B curved to be convex toward the brake pad 4 side and brought into contact with the second contact plane 424a. In addition, the second inclined surface 426 and the second contact section 424 are arranged on the end side of the back plate 42 in the rotor circumferential direction, as compared with the first embodiment. Even with such a configuration, the same effect as that of the first embodiment is obtained.

### Third Embodiment

The third embodiment is different from the second embodiment mainly in the configuration of the contact section. Therefore, different portions will be explained. In the description of the third embodiment, the drawings and explanations of the first and second embodiments can be referred to.

As shown in FIGS. 9 and 10, a first contact section 423C of the third embodiment is formed in a concave shape corresponding to the curved portion 513B so as to be slidable in the axial direction of the rotor with respect to the curved portion 513B. That is, the first contact section 423C is a groove extending in the axial direction of the rotor formed in the first inclined surface 425. At least a part (most part in the present embodiment) of the curved portion 513B is in contact with the concave shaped first contact section 423C. A first contact plane 423Ba is a part of the concave shaped first contact section 423C and corresponds to the bottom surface (band-shaped plane) portion of the first contact section 423C. The first contact plane 423Ba and the base point 51a are located on the first virtual plane Z1. The curved portion 513B presses the first contact section 423C (concave portion) and exerts a biasing force in a direction perpendicular to the first contact plane 423Ba.

Similarly, a second contact section 424C is formed in a concave shape corresponding to the curved portion 523B so as to be slidable in the axial direction of the rotor with respect to the curved portion 523B. That is, the second contact section 424C is a groove extending in the axial direction of the rotor formed in the second inclined surface 426. At least a part (most part in the present embodiment) of the curved portion 523B is in contact with the concave shaped second contact section 424C. A second contact plane 424Ba is a part of the concave shaped second contact section 424C and corresponds to the bottom surface (band-shaped plane) portion of the second contact section 424C. The second contact plane 424Ba and the base point 52a are located on the second virtual plane Z2. The curved portion 523B presses the second contact section 424C (concave portion) and exerts a biasing force in a direction perpendicular to the second contact plane 424Ba.

As described above, in the third embodiment, the biasing members 51B, 52B are plate springs including the curved portions 513B, 523B, which are portions to be brought into contact with the contact sections 423C, 424C and curved so as to be convex toward the brake pad 4 side, and the contact sections 423C and 424C are formed in a concave shape corresponding to the curved portions 513B and 523B so as to be slidable in the axial direction of the rotor with respect to the curved portions 513B and 523B. According to this configuration, in addition to the effect of the first embodiment, occurrence of slippage is further suppressed by the concave-convex engagement of the contact sections 423C, 424C and the biasing members 51B, 52B. That is, according to the third embodiment, the fluctuation of the spring characteristic can be further suppressed.

### Fourth Embodiment

The fourth embodiment differs from the first embodiment in terms of the configuration of the inclined surface and the contact section. Therefore, different portions will be explained. In the description of the fourth embodiment, the drawings and explanations of the first to third embodiments can be referred to.

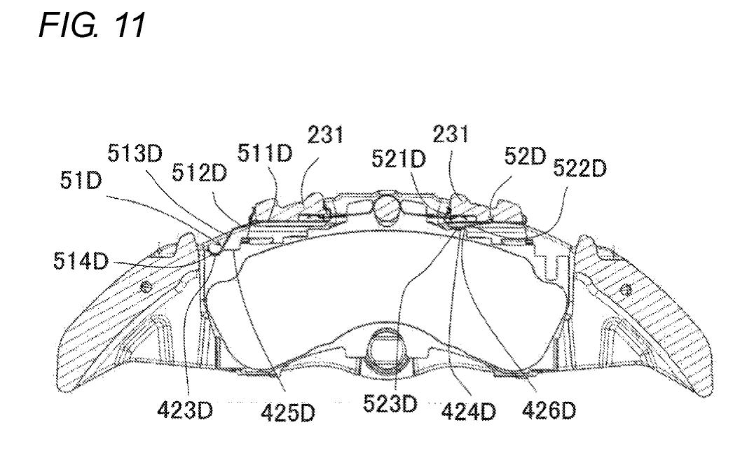

As shown in FIG. 11, a first biasing member 51D is a plate spring, and is configured by a base end portion 511D fixed to the bridge 231, a first portion 512D projecting from the base end portion 511D, a second portion 513D extending so as to curve toward the brake pad 4 side from the first portion 512D, and a curved portion 514D extending from the distal end of the second portion 513D and curved so as to be convex toward the brake pad 4 side. The base point 51a of the first biasing member 51D is the root of the second portion 513D (distal end of first portion 512D).

A second biasing member 52D is a plate spring and is configured by a base end portion 521D fixed to a bridge 231 different from the above, a first portion 522D projecting from the base end portion 521D, and a curved portion 523D extending from the distal end of the first portion 522D and curved so as to be convex toward the brake pad 4 side. The base point 52a of the second biasing member 52D is the root of the first portion 522D.

Unlike the third embodiment, a first contact section 423D is a groove formed on a flat surface 425D that does not coincide with a virtual plane defined by a plane including the rotation axis Y. The first contact section 423D is formed in a concave shape corresponding to the curved portion 514D. The curved portion 514D is brought into contact with the first contact section 423D and presses the first contact section 423D. Similarly, a second contact section 424D is a groove formed on a flat surface 426D that does not coincide with a virtual plane defined by a plane including the rotation axis Y. The second contact section 424D is formed in a concave shape corresponding to the curved portion 523D. The curved portion 523D is brought into contact with the second contact section 424D and presses the second contact section 424D.

According to the fourth embodiment, the biasing state as in the first to third embodiments does not occur at the time of no-brake operation (initial state), and the biasing state similar to that of the first to third embodiments occurs with respect to the contact sections 423D, 424D when the brake pad 4 is rotating. Since the contact sections 423D, 424D constitute a concave portion, the biasing force can be received by the concave shaped engagement surface, and the biasing members 51D, 52D can apply a biasing force in a direction opposite to the rotating direction with respect to the contact sections 423D, 424D during the rotation of the brake pad 4. Thus, occurrence of slippage can be suppressed, and fluctuation in spring characteristics can be suppressed.

### OTHERS

The present invention is not limited to the embodiment described above. For example, the biasing members 51 and 52 may be spring springs or the like. In addition, the portions of the outer peripheral surface of the back plate 42 where the contact sections 423, 424 are formed are not limited to the portions (inclined surfaces 425, 426) on the outer side in the rotor radial direction, and may be the portions on the inner side in the rotor radial direction, the portions at one end side in the rotor circumferential direction or the portions on the other end side in the rotor circumferential direction. Furthermore, the supporting shaft supporting the brake pad 4 may be provided at the central portion of the brake pad 4. Moreover, only one biasing member may be used. In addition, the magnitude relationship of the biasing force between the biasing members 51, 52 in the initial state may be inverted from that of the above embodiment, or may be the same. Furthermore, the present invention can also be applied to a floating type caliper structure. However, as the brake pad 4 is assumed to be rotating in the opposing caliper structure as in the present embodiments, the effects of the present invention function more effectively.

Furthermore, “perpendicular” in the present invention is a concept including a design error and a slight difference, and it is a concept including a predetermined slight difference range (e.g., 90°±5°, more strictly 90°±2°) with respect to perpendicular. Furthermore, “the contact planes 423a and 424a coincide with the virtual planes Z1 and Z2” is a concept including a design error and a slight difference, and is a concept in which an angle formed by the contact plane 423a (424a) and the virtual plane Z1 (Z2) includes a predetermined slight difference range (e.g., 0°±5°, more strictly 0°±2°) with 0° as the center. The term “located on the virtual planes Z1 and Z2” is also a concept similarly including design errors and slight differences. Furthermore, the contact plane can also be said to be the acting surface of the biasing force.

1. (canceled)

2. (canceled)

3. (canceled)

4. (canceled)

5. A caliper assembly comprising:
a caliper disposed so as to cross one portion of an outer peripheral portion of a disc rotor;
a brake pad incorporated in the caliper so as to be movable in an axial direction of the rotor, which is an axial direction of the disc rotor, and rotatable around a rotation axis parallel to the axial direction of the rotor with respect to the caliper;
a piston assembled to the caliper to press the brake pad toward the disc rotor; and
biasing members which bias the brake pad to hold the brake pad,
wherein
the brake pad has contact sections, which are sections in contact with the biasing members,
the contact sections have contact planes that coincide with virtual planes including the rotation axis of the brake pad,
the biasing members include a first biasing member that biases the brake pad toward one side in a rotating direction with respect to the brake pad and a second biasing member that biases the brake pad toward the other side in the rotating direction with respect to the brake pad, and each bias the contact plane in a direction perpendicular to the contact plane,
the contact sections include a first contact section which is a section in contact with the first biasing member, and a second contact section which is a section in contact with the second biasing member, and
a biasing force of the first biasing member is larger than a biasing force of the second biasing member.

6. The caliper assembly according to claim 5, wherein the biasing member is arranged such that a base point where a biasing force is generated is located on a perpendicular line of the contact plane or on the virtual plane.

7. The caliper assembly according to claim 5, wherein
the biasing member includes a curved portion, which is a portion that comes into contact with the contact section and which is curved so as to be convex on the brake pad side, and
the contact section is formed in a concave shape corresponding to the curved portion so as to be slidable in the axial direction of the rotor with respect to the curved portion.

8. The caliper assembly according to claim 6, wherein
the biasing member includes a curved portion, which is a portion that comes into contact with the contact section and which is curved so as to be convex on the brake pad side, and
the contact section is formed in a concave shape corresponding to the curved portion so as to be slidable in the axial direction of the rotor with respect to the curved portion.
